(19) United States
(12) Patent Application Publication
(10) Pub. No.: US 2024/0122775 A1
(43) Pub. Date: Apr. 18, 2024

(54) AN IMPROVED WHEELCHAIR

(71) Applicant: WHANAUKA LIMITED, Auckland (NZ)

(72) Inventor: Marcus William THOMPSON, Otaki (NZ)

(73) Assignee: WHANAUKA LIMITED, Auckland (NZ)

(21) Appl. No.: 18/270,234

(22) PCT Filed: Dec. 28, 2021
(86) PCT No.: PCT/NZ2021/050237

§ 371 Date: Jun. 29, 2023

(30) Foreign Application Priority Data
Dec. 29, 2020 (AU) 2020904861

(51) Int. Cl. A61G 5/10; B60G 21/05

(52) U.S. Cl. CPC A61G 5/1089; A61G 5/1078; A61G 5/1081; B60G 21/05; B60G 2300/24; B60G 2800/0194

(57) ABSTRACT

Embodiments of the present invention provide a wheelchair for a wheelchair rider, the wheelchair having first and second wheel arms each pivotally mounted so as to allow the alignment of the first arm to move relative to the second arm through a range of relative alignment in response to the rider leaning laterally. First and second wheel mounts are provided on first and second arms respectively to mount respective first and second wheels with central axes of first and second wheels able to move in an arc about the point of pivotal mounting of the respective first or second arm.

### TECHNICAL FIELD

This invention relates to an improved wheelchair. In particular the invention relates to a wheelchair with improved control.

### BACKGROUND ART

Wheelchairs are well known. A common configuration of wheelchair has two wheels located at the sides of the chair and mounted on a chassis. The chassis also mounts a seat for the rider. The wheelchair is typically controlled by the rider applying forward and reverse torques to the wheels to steer the chair. This configuration of wheelchair has shortcomings in rider control of the chair.

It would be of advantage to have improvements in the field of wheelchairs which provide for improved control, or at least to provide the public with a useful choice.

### DISCLOSURE OF INVENTION

According to one aspect the invention provides a wheelchair having a platform for the rider wherein the platform is able to tilt laterally with respect to a direction of forward travel of the wheelchair in response to the rider of the wheelchair leaning.

Said transfer of weight of the rider may cause one of the first and second wheels to move relatively upwards or downwards relative to the other of the first and second wheels on an opposite side of the wheelchair.

The wheelchair may comprise a means to distribute weight between the first and second wheels located at opposite sides of the wheelchair.

The means to distribute weight may comprise a torsion element.

The means to distribute weight may comprise a crossbar which mounted at a pivot located between the first and second wheels on opposite sides of the wheelchair.

The wheelchair may comprise first and second wheel-mounting linkages which mount first and second wheel respectively and allow the first wheel to move upward relative to the second wheel. The wheel-mounting linkages may comprise said swing arms.

The wheelchair may comprise first and second swing arms which allow first wheel move upward relative to the second wheel.

The wheelchair may comprise a support linkage which mounts support wheels wherein the support linkage moves the support wheel of a first side or a support wheel of a second side with the respective first or second wheel.

The wheelchair may comprise a rider-supporting platform which is operable to tilt with respect to a mid-chassis.

Another aspect of the invention provides a wheelchair comprising a rider-supporting platform mounted on a mid-chassis, and a wheel-mounting platform operable to mount first and second wheels on opposite sides of the wheelchair, wherein the rider supporting platform is operable to tilt relative to the mid-chassis and wherein the height of a first wheels is operable to raise relative to the second wheel to allow the mid-chassis to tilt relative to a surface on which the wheelchair is riding.

The wheelchair of claim may comprise a weight distribution means operable to distribute weight between the first and second wheels.

The weight distribution means may comprise a torsion element.

The weight distribution means may comprise a crossbar mounted at a pivot mount located between the first and second wheels wherein the pivot may be rigidly connected to the mid-chassis to transfer weight from the mid-frame to the crossbar.

The wheelchair may comprise a support assembly operable to mount support wheels which support the wheelchair against titling longitudinally wherein the support assemblies are operable to raise a support wheel on the side of the wheelchair of the first wheel with the first wheel and are operable to raise a support wheel on the side of the wheelchair of the second wheel with the second wheel.

According to one aspect the invention provides a wheelchair having a platform for the rider wherein the platform is able to tilt laterally with respect to a direction of forward travel of the wheelchair.

According to one aspect the invention provides a wheelchair having a central chassis able to support the weight of a rider wherein the central chassis is able to tilt laterally with respect to a direction of forward travel of the wheelchair.

According to another aspect the invention provides a wheelchair having a platform for the rider wherein the platform is able to tilt laterally, with respect to a direction of forward travel of the wheelchair, in response to a torque applied by the rider of the wheelchair.

According to another aspect the invention provides a wheelchair having a platform for the rider wherein the platform is able to tilt laterally, with respect to a direction of forward travel of the wheelchair, in response to a shift in weight of the rider of the wheelchair.

According to another aspect the invention provides a wheelchair having a platform for the rider wherein the platform is able to tilt laterally, with respect to a direction of forward travel of the wheelchair, in response to the rider of the wheelchair leaning. The leaning may be in towards the centre of a turn. The leaning may be upwards with respect to a sloped surface the wheelchair may be traversing.

According to one aspect of the present invention there is provided a wheelchair for a wheelchair rider, the wheelchair comprising:
first and second wheel arms each pivotally mounted so as to allow the alignment of the first arm to move relative to the second arm through a range of relative alignment;
first and second wheel mounts provided on first and second arms respectively to mount respective first and second wheels with central axes of first and second wheels able to move in an arc about the point of pivotal mounting of the respective first or second arm.

The wheelchair may comprise a support for the weight of the rider.

The support may be able to transfer a torque relative to first and second axes about which the first and/or second wheel arms are pivotally mounted.

The support may be able to transfer weight of the rider relatively to the first and second wheel arms and respective first and second wheels mounted thereon.

The first and second wheel arms may be arranged such that each of the first and second axes at which a first or second arm respectively is mounted is separated from an axis of the respective first or second wheel in a direction of travel of the respective wheel. In one example, the axis of the first or second wheel follows the axis of the pivotal mount on the first or second arm relative to a forward direction of movement of the wheelchair. In another example, the axis of the first or second wheel leads the axis of the pivotal mount on the first or second arm relative to a forward direction of movement of the wheelchair.

The first and second wheel arms may be arranged such that each of the first and second axes at which a first or second arm respectively is mounted is separated from respective mounts on the respective arm for the respective first or second wheel in a direction of travel of the respective wheel.

The first and second wheel arms may be arranged at an angle away from vertical in an axis parallel to a plane of a respective mounted wheel.

Said torque which is able to be applied by the support for the rider may move the first wheel arm away from relative alignment with the second wheel arm.

The first and second wheel arms may be pivotally mounted at a common axis. This may allow each of the first and second wheels to move orbitally about a substantially common axis. This may allow the position of each of the first and second wheels to move relatively forward or aft of the other of the first or second wheels. This may allow the position of each of the first and second wheels to move relatively upwards or downwards of the other of the first or second wheels.

Alternatively, the first and second arms may be mounted so as to have a common axis when substantially no torque is applied at the support.

Said torque and/or said transfer of weight of the rider may cause one of the first and second wheels to move relatively upwards or downwards relative to the other of the first and second wheels. Movement of one of the first and second wheels relative to a surface on which both wheels are supported may allow the support to lean towards the surface. This may be in a direction of said torque applied at the support. This may be in a direction of said transfer of weight at the support.

Embodiments of the present invention provide a wheelchair with a support for a rider and wheels mounted on arms which are mounted pivotally with respect to the support so that a torque applied to the support causes a first wheel to move upwards relative to a second wheel so to cause the support to lean relative to a surface supporting the wheels.

The arms may be pivotally mounted at axes which are transverse to a direction of travel of the wheelchair. The wheel mounts provided on the arms may provide axes of rotation of the wheels which are transverse to a direction of travel of the wheelchair.

The wheelchair may comprise a biasing means able to bias the first arm relatively towards alignment with the second arm.

The biasing means may comprise a resilient element which deforms as the first arm is moved relatively out of alignment with the second arm.

The biasing means may comprise a torsion element. The torsion element may act to return the first and second arms into relative alignment so as to resist a torque and/or transfer of the weight of the rider applied at the support.

The support may comprise an axle and a mount for a platform for the rider.

The mount may be operable to allow the platform to lean relative to the support.

The wheelchair may comprise pivotal mounts for the first and second arms.

The pivotal mounts may be formed integrally with the biasing element.

The wheelchair may comprise a central chassis which provides a mount for the support and mounts for the first and second arms.

The mount for the support may comprise a bore which is able to receive a rod on which a platform for the rider is mounted.

The mount for the support may be operable to allow the support to tilt relative to the pivotal mount for the first wheel arm and/or the pivotal mount for the second wheel arm. The mount for the support may comprise a stop to limit the degree of said tilt of the support.

The mounts for the first and second wheel arms may each comprise a bore for an axle which provides the pivotal mount for the wheel arm.

The central chassis may comprise first and second chassis arms to support respective first and second pivotal mounts for respective first and second wheel arms.

The wheelchair may comprise a biasing means able to bias a central axis of the first wheel relatively towards alignment with a central axis of the second wheel. This may act to right the platform for the rider.

The biasing means may comprise a first resilient element connecting the first chassis arm to a part of the chassis proximate the mount for said bore for said rod on which a platform for the rider is mounted.

The biasing means may comprise a second resilient element connecting the first chassis arm to a part of the chassis proximate the mount for said bore for said rod on which a platform for the rider is mounted.

Said first and second resilient elements may be formed integrally with each other.

The wheelchair may comprise a bracing wheel assembly arranged to brace the support against rotation forward and/or aft relative to the direction of movement of the wheelchair.

The bracing wheel assembly may comprise bracing chassis connecting a cross bar the support for the rider, wherein the cross bar mounts bracing wheels.

The bracing wheel assembly may be operable to allow the cross bar to rotate transversely to the direction of travel of the wheelchair to allow the bracing wheels mounted on the cross bar to maintain contact with a surface on which the wheelchair is supported when the first wheel is raised relative to the second wheel.

The bracing assembly may comprise a biasing element able to bias the cross bar towards a position relative to the support for the rider which is parallel with the support for the rider.

The bracing wheel assembly may comprise a torsion element able to provide a restoring torque to align the first wheel arm with the second wheel arm.

The bracing wheel assembly may comprise a torsion element able to provide a restoring torque towards a position parallel with the cross bar of the bracing assembly.

According to one aspect of the invention there is provided a wheelchair the wheelchair comprising a platform to support a rider, a right linkage assembly which provides a right wheel mount to mount a right wheel, and a left linkage assembly which provides a left wheel mount to mount a left wheel wherein one of the right and left wheel mounts are able to move upward relative to the other.

A wheel-supporting linkage assembly may be operable to allow the wheel to move in a plane substantially parallel to a plane in which the wheel rotates.

The wheelchair may comprise drive wheels mounted on the wheel-mounting linkages.

A wheel-supporting linkage assembly may be operable to allow one of the right or left wheels to move upward relative to the other.

The wheelchair may comprise a crossbar connecting the right wheel-supporting linkage assembly and the left wheel supporting linkage assembly.

The crossbar may be rigid and mounted on a pivot to mechanically couple the right and left wheel-mounting linkage assemblies.

The wheelchair may comprise a mid-chassis to which a platform for the rider is connected.

A pivot mount at which the crossbar is mounted may be connected rigidly to the mid-frame.

This may allow the pivot mount to act as a fulcrum for the crossbar. The pivotally mounted crossbar may distribute weight between the wheel mounts. The weight thus distributed might be distributed substantially evenly between the two wheel-mounting linkage assemblies. The pivotally mounted crossbar may limit a range of movement of one of the wheel mounts relative to the other.

The pivot mount may be connected to the mid chassis.

The pivot mount may be provided on the mid chassis.

The pivot at which the crossbar is mounted may be located between the right and left wheel-mounting linkage assemblies. The crossbar may be operable to share the weight of the rider onto right and left wheel-mounting linkage assemblies. The crossbar may be operable to match the weight of the rider borne by each of the right and left wheel-mounting linkage assemblies.

In one example the wheelchair is situated on a slope which rises transversely to a direction of movement of the wheelchair. In this scenario a wheel-mounting linkage assembly mounting a wheel on an upper side of the slope, a right wheel-mounting linkage assembly for example, is located upwards relative to the other wheel-mounting linkage assembly. The mounted wheel on the upper side is similarly located above the wheel on the other side. In this scenario one exemplary embodiment has substantially equal weight on each wheel-mounting linkage assembly and mounted wheel due to the pivotally mounted crossbar distributing weight of the wheelchair and rider between the wheel-mounting linkage assemblies and mounted wheels. However, the relative position of the right wheel above the left wheel allows the mid-chassis to remain in a horizontal orientation, tilted up towards the slope.

A linkage assembly may comprise a swingarm operable to swing in a plane substantially parallel to a plane in which the wheel mounted on the respective linkage assembly rotates. This may allow a wheel mount provided by one of the right and left wheel-mounting linkage assemblies to move upwards relatively to the other. This may allow a wheel mount provided by one of the right and left wheel-mounting linkage assemblies to move upwards relatively to the other.

A swingarm swinging in a plane substantially parallel to a plane in which the wheel mounted on the respective linkage assembly rotates may cause the wheel mount of one of the right or left wheel-mounting linkages to move upwards and forward relative to the wheel mount of the other wheel-mounting linkage assemblies.

In alternative embodiments a swingarm swinging in a plane substantially parallel to a plane in which the wheel mounted on the respective linkage assembly rotates may cause the wheel mount of one of the right or left wheel-mounting linkages to move upwards and rearward, with respect to a forward direction of movement of the wheelchair, relative to the wheel mount of the other wheel-mounting linkage assemblies.

The wheelchair may comprise a rider-support assembly operable to support the weight of a rider. The rider-support assembly may comprise a seat platform to support an attached seat for a rider.

The seat platform may be operable to tilt laterally to a direction of forward travel of the wheelchair.

The seat platform may be operable to tilt side to side relative to a direction of forward travel of the wheelchair.

The seat platform may be operable to tilt longitudinally to a direction of forward travel of the wheelchair.

The seat platform may be operable to tilt forward and backward relative to a direction of forward travel of the wheelchair.

The seat platform may be supported by double ended rods. The rods may be arranged in a rectangular pattern.

The rods may be operable to allow the seat platform to move through a concave arc. The rods may be operable to allow the seat platform to move through a concave arc such that a neutral position of the seat platform is at the nadir of the arc.

The rods may be arranged to allow movement which can occur in two planes separately.

The rods may be arranged to allow movement which can occur in two planes concurrently.

The rods may be arranged to allow movement which can occur in two planes separately or concurrently.

The rider support assembly may comprise biasing elements to provide stability in the neutral position. The rider support assembly may comprise compression springs to provide stability in the neutral position.

The rider support assembly may comprise biasing means to provide extra help to return from an out-of-vertical position to the neutral position. The rider support assembly may comprise compression springs to provide extra help to return from an out-of-vertical position to the neutral position.

The degree of bias and/or force of spring and/or range of extension of rod assemblies under force of a rider and/or the range of movement pf the seat platform under force of the rider may be selected and/or tuned. The tuning may be by section of a spring rate.

The compression springs may be further operable to act as end stops in their solid state avoiding a collision of the seat pan with the rear wheels in the lateral direction and for the seat pan to tilt back.

The wheelchair may comprise support-wheel mounts for right and left support wheels for the wheelchair. The support-wheel mounts may be provided on support linkage assemblies operable to move mounts for the support wheels as mounts for drive wheels move. In one example a mounted drive wheel on a first side of the wheelchair moves upward and forward relative to a drive wheel mounted on an opposite, second side of the wheelchair and a support on the first side is moved upward and forward relative to a support wheel on the opposite, second side of the wheelchair. The mounted drive wheel on a first side of the wheelchair may be referred to herein as the first wheel. The mounted drive wheel on a second side of the wheelchair may be referred to herein as the second wheel.

In this example the support linkages maintain the position of the mount for a support wheel relative to a mount for a drive wheel. In this example distribution of weight between drive wheels and support wheels on the same side is substantially maintained.

The support linkage assemblies may be arranged maintain the position of the mount for a support wheel relative to a mount for a drive wheel.

The support linkage may be mounted on the mid-chassis. The mid-chassis may provide a pivot mount for the support linkages.

The mid-chassis may support a footrest platform.

The mid chassis may support a seat platform operable to support a rider. The seat platform for the rider may be connected to the mid-chassis by linkages that allow the seat platform to tilt relative to the mid-chassis.

The seat platform for the rider may be connected to the mid-chassis by linkages that allow the seat platform to till laterally to a direction of movement of the wheelchair, said tilting relative to the mid-chassis.

The seat platform for the rider may be connected to the mid-chassis by linkages that allow the seat platform to tilt sidewards to a direction of movement of the wheelchair, said tilting relative to the mid-chassis.

The seat platform for the rider may be connected to the mid-chassis by linkages that allow the seat platform to tilt laterally to a direction of movement of the wheelchair, said tilting relative to the mid-chassis.

The seat platform for the rider may be connected to the mid-chassis by linkages that allow the seat platform to till forward or backward to a direction of movement of the wheelchair, said tilting relative to the mid-chassis.

The seat platform for the rider may be connected to the mid-chassis by linkages that allow the seat platform to tilt longitudinally to a direction of movement of the wheelchair, said tilting relative to the mid-chassis.

The seat platform for the rider may be connected to the mid-chassis by linkages that allow the seat platform to tilt relative to pivotal mount for the crossbar.

In one aspect the invention provides a wheelchair having a rider platform which is operable to be articulated and a wheel-mounting assembly which is operable to be articulated wherein the rider platform can be articulated independently of the wheel-mounting assembly.

The rider platform may be articulated to tilt.

The wheelchair may comprise a mid-chassis to mount the rider platform.

The rider platform may be articulated to tilt relative to the mid-chassis. This may allow a rider to shift their weight relative to the mid-chassis. This may allow a rider to apply a torque to the mid-chassis.

The wheel-mounting assembly may be operable to be articulated to allow a wheel mount on a first side of the wheelchair to be raised relative to a mount on a second chair.

The wheel-mounting assembly may comprise a force-distribution means to distribute force between wheel mounts on first and second sides of the wheelchair.

The force-distribution means may be operable to substantially evenly distribute weight to wheel mounts on first and second sides of the wheelchair as a wheel mount on a first side moves over a range of height relative to another wheel mount on a second side of the wheelchair.

The wheel-mounting assembly may be operable to move a wheel mount on a first side of the wheelchair relatively upward or downward relatively to a wheel mount on a second side of the wheelchair to maintain a substantially even weight on each of said wheel mounts.

The wheel-mounting assembly may be operable to move a wheel mount on a first side of the wheelchair relatively upward or downward relatively to a wheel mount on a second side of the wheelchair in response to a shift of weight of the rider relative to the mid-chassis.

The wheel-mounting assembly may be operable to move a wheel mount on a first side of the wheelchair relatively upward or downward relatively to a wheel mount on a second side of the wheelchair in response to a torque applied by the rider to the mid-chassis. The applied torque may be transverse to a direction of travel of the wheelchair.

The force-distribution means may be a crossbar. The crossbar of the force-distributing means may be pivotally mounted on the mid-chassis.

In one example, a rider shifts weight transversely to a direction of movement of the wheelchair to place more weight on a first side of the mid-chassis, causing the wheel mount, and mounted wheel, on the first side to move upwards relatively to the wheel mount on the second side of the wheelchair. This upward movement may be caused by the pivotally mounted crossbar distributing weight evenly between the wheel mounts on the first and second sides of the wheelchair. This may be in a dynamic situation, such as when the wheelchair is cornering.

In another example, the wheelchair moves on a sloped with a wheel on a first side of the wheelchair resting on an elevated part of the surface compared to a part of the surface on which a wheel of the second side rests. The force distribution means, which in this example is a crossbar pivotally mounted to the mid-chassis causes the wheel mount, and mounted wheel, on the first side to move upwards relatively to the wheel mount, and mounted wheel, on the second side of the wheelchair.

As used herein ‘linkage assembly’ is any assembly of mechanically linked elements, such as an assembly of rigid elements pivotally connected to other elements.

As used herein ‘a’ is used in the inclusive sense and a phrase involving ‘a’ given feature does not exclude ‘another’ given feature.

As used herein the term ‘comprise’ is used in the inclusive sense as ‘including’ and not in the sense of ‘consisting of.’

### BRIEF DESCRIPTION OF THE DRAWINGS

Example embodiments of the invention are now discussed with reference to the drawings in which:

FIG. 1 shows a top view of a wheelchair according to a preferred embodiment of the invention;

FIG. 2 shows a rear elevation view of a wheelchair of the same embodiment as FIG. 1;

FIG. 3 shows a side elevation view of the wheelchair of the embodiment of FIGS. 1 and 2 with first and second wheels removed to reveal detail;

FIG. 4 shows a rear elevation view of the wheelchair of the same embodiment as FIGS. 1 to 3 with the wheel arms and wheels configured to traverse a slope;

FIG. 5 shows a side elevation view with the wheelchair of the embodiment of FIGS. 1 to 4 in a leaned configuration;

FIG. 6 shows a rear elevation view of the wheelchair of the same preferred embodiment;

FIG. 7 shows a side elevation view of the wheelchair of the same embodiment with first and second wheels removed;

FIG. 8 shows a front elevation view of a wheelchair according to the same embodiment;

FIG. 9 shows a side elevation view of a wheelchair also of the same embodiment;

FIG. 10 shows a plan view of a central chassis of a wheelchair according to the same embodiment again;

FIG. 11 shows a close-up side elevation view illustrating the central chassis;

FIGS. 12 and 13 show central chassis assemblies according to alternative embodiments of the invention;

FIG. 14 shows front elevation view a wheelchair according to a further embodiment;

FIG. 15 shows a rear view of a wheelchair according to the embodiment of FIG. 14;

FIG. 16 shows a side view of a wheelchair according to the same embodiments as FIGS. 14 and 15;

FIG. 17 shows a perspective view of a wheelchair according to the embodiment of FIGS. 14 to 16;

FIG. 18 shows a rear elevation view of a wheelchair of the embodiment of FIGS. 14 to 18 with the right wheels raised;

FIG. 19 shows a side elevation of a wheel of the embodiment of FIGS. 14 to 18 with the right wheel raised as would occur when a rider leans towards the right;

FIG. 20 shows a perspective view of a wheelchair according to the embodiment of FIGS. 14 to 17 with the right wheels raised relative to the left wheels;

FIG. 21 shows a perspective view of a rider-support assembly of a wheelchair according to the embodiment of FIGS. 14 to 18; and

FIG. 22 shows an alternative view of the rider-support assembly of FIG. 21.

### BEST MODES FOR CARRYING OUT THE INVENTION

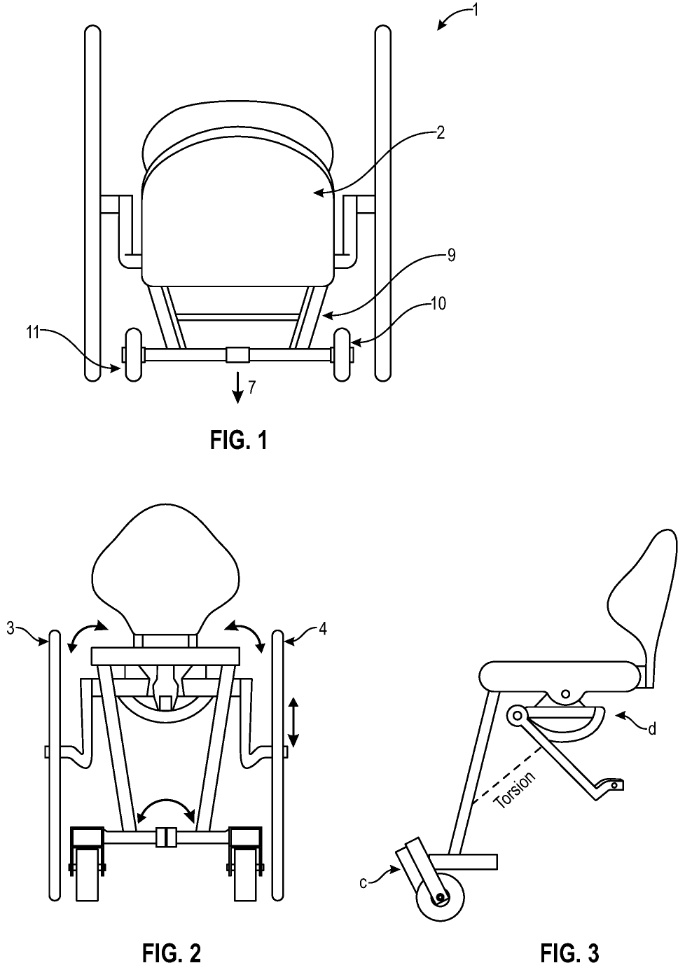

FIG. 1 shows a top view of a wheelchair 1 according to a preferred embodiment of the invention.

FIG. 2 shows a rear elevation view of a wheelchair 1 of the same embodiment as FIG. 1.

Referring to FIGS. 1 and 2, the wheelchair 1 has a seat 2 to provide a support for the weight of the wheelchair rider (not shown). A first wheel 3 and a second wheel 4 are mounted on respective first wheel arm 5 and second wheel arm 6 to support the wheel arms above a surface (not shown) on which the wheelchair travels. In this embodiment the wheelchair 1 has a forward direction of travel 7 down the page as shown. The first and second wheel arms are pivotally mounted to a central chassis 8 which supports the seat 2. The pivot for each arm is located between the respective wheel and an end wheelchair. The reader will appreciate this as allowing substantially as large a range of movement of the wheel upwards or downwards as possible for a given length of arm.

A bracing assembly 9 has bracing wheels 10 and 11 mounted on a cross bar 12. The wheels are castor wheels which trail their respective mounts on the cross bar 12 in the direction of forward travel. The cross bar is separated from the axis of the first and second wheels by a distance to brace the seat against rotation forward in the direction of travel 7 of the wheelchair 1. The cross bar 12 with mounted wheels 10 and 11 also provides lateral bracing for the seat against rotation lateral or transverse to the direction of travel 7.

The central chassis 12 is mounts a support chassis 13 for the seat 2. The central chassis 12 also provides first and second bores for pivotal mounting of the first wheel arm 5 and for second wheel arm 6 about first wheel arm pivot axis and second wheel arm pivot axis. In this embodiment the first and second wheel arm pivot axes are common to each other or aligned.

The first wheel arm 5 has a wheel mount 14 for the first wheel 3 with a first wheel axis at a central axle (not shown). The second wheel arm 6 has a wheel mount 15 for the second wheel 4 with a second wheel axis at a central axle (not shown) of the wheel. When the wheel arms are aligned with each other, the first wheel axis and the second wheel axis are common to each other or aligned. As the wheel arms are able to pivot at the axis of the bores of the central chassis, the first wheel axis is able to move upwards and backward into the page, as shown in FIG. 2, relative to the second wheel axis. As the wheel arm defines an arc about the pivot axis of the wheel arm for the wheel axis, the first wheel axis will also move backwards relative to the second wheel axis. This will be up the page as shown in FIG. 1. As the wheel arm moves in an arc it may be recognised by the reader as a swing arm.

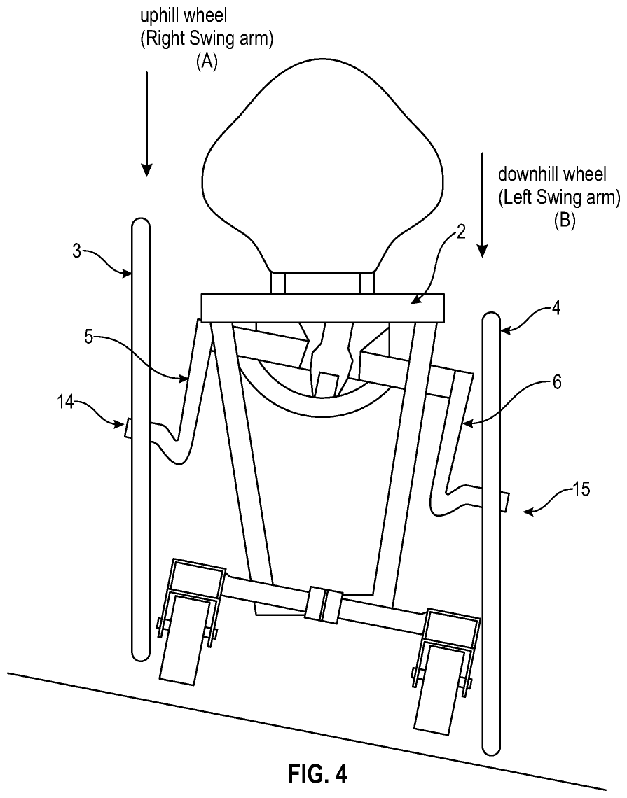

FIG. 3 shows a side elevation of the wheelchair with first and second wheels removed to reveal detail. FIG. 3 shows the seat 2 mounted to the support chassis by a rod 16 which is located aft of and above the pivot mount 17 for the first wheel arm 3. As shown in FIG. 3 the wheel arm has an elbow 18 with the wheel mount 14 located aft of the main part of the arm as shown.

FIG. 3 shows the bracing chassis extending down and forward from the platform for the seat. The castor wheels 10 and 11 are shown trailing their mounts 19 and 20 on the cross bar 12.

FIG. 4 shows a rear elevation of the wheelchair 1 of the same embodiment as FIGS. 1 to 3 with the wheel arms and wheels configured to traverse a sloped surface 21 with the seat substantially horizontally aligned.

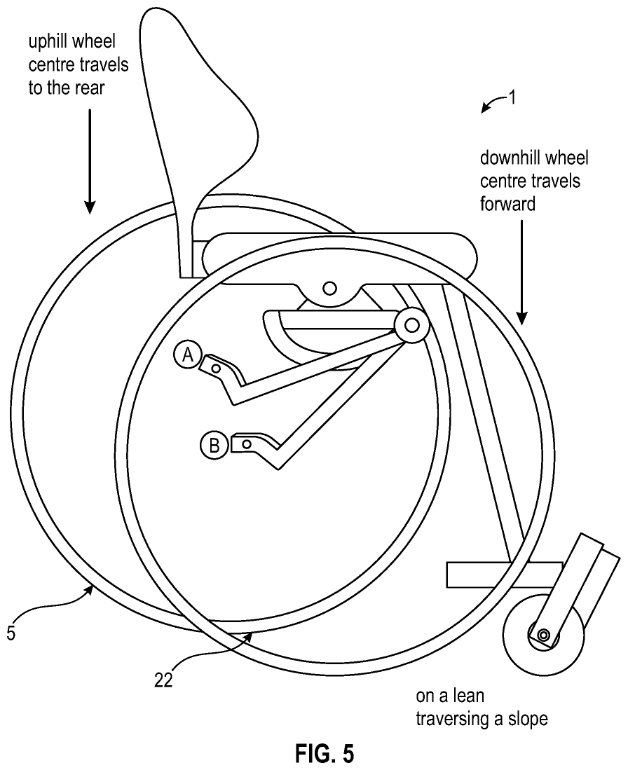

FIG. 5 shows a side elevation with the wheelchair 1 in a leaned configuration with the seat 2 tilted towards a centre of a turn, for example. The first wheel arm 3 is pivoted relative to the second wheel arm 4 to swing rearward to cause the first wheel mount 14 to move on an arc rearward and upward relative to the second wheel mount 15. This causes the bottom, load bearing edge 22 of the first wheel 5 to move upwards to lean the chair and to allow the seat and platform supporting the seat to tilt towards the first wheel 5.

The movement of the first wheel arm relative to the second can be initiated by a torque applied by the seat, such as by a shift of weight of the rider. This may be initiated by the rider leaning inwards toward the centre of a turn. This may be initiated also by the rider leaning upwards towards a vertical orientation when the wheelchair is traversing a sloped surface.

Torsion elements of the wheelchair provide a restoring torque to the first wheel arm relative to the second wheel arm. In this embodiment torsion elements are arranged to provide restoring torque acting to align to return the first and second arms towards relative alignment. The reader will appreciate the torsion elements as distributing weight of the rider between the arms and first and second wheels mounted on respective arms. The reader will appreciate the torsion elements as distributing force of the rider between the arms and first and second wheels mounted on respective arms. The reader will appreciate the torsion elements as transferring force between the arms and first and second wheels mounted on respective arms. The arms might be considered to be couple to distribute the weight of the rider and part of the wheelchair between the assemblies mounting the first and second wheels.

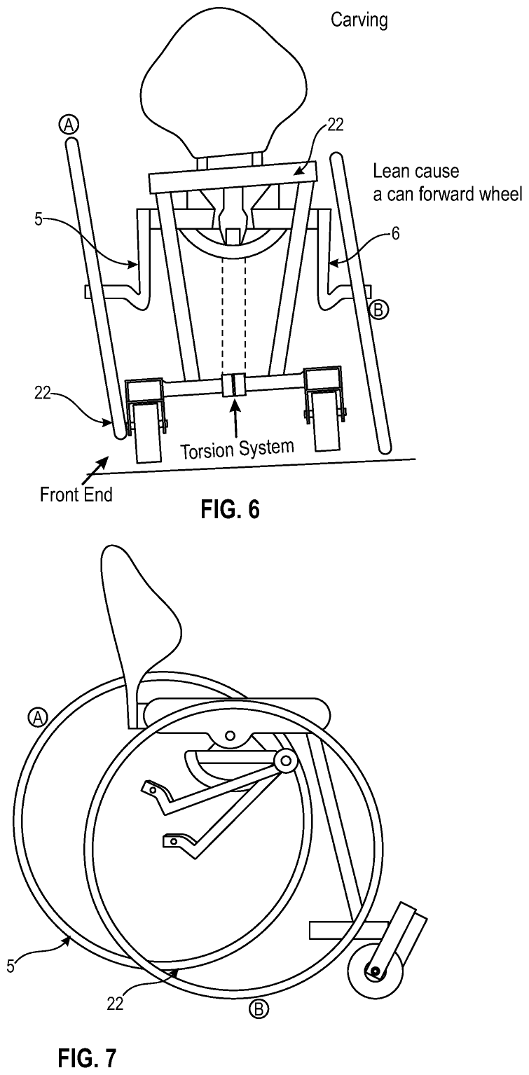

FIG. 6 shows a rear elevation of the wheelchair of the same preferred embodiment. FIG. 6 shows the support chassis 13 acting as a stem to mount the seat 2 to the central chassis 9. The support chassis is pivotally mounted to the central chassis 8 which has a stop (not shown) to limit the degree of pivoting of the support chassis 13. The pivoting support chassis allows the seat to tilt as the rider leans to transfer weight or apply a torque against the action of the torsion element to pivot the first arm relative to the second arm to allow the seat to tilt further.

FIG. 6 also shows the crossbar 12 of the bracing assembly 9 rotated at a central pivot mount 23 to allow the bracing wheels 10 and 11 to remain in contact with the surface supporting the wheelchair while the wheelchair ‘leans’ on a flat surface.

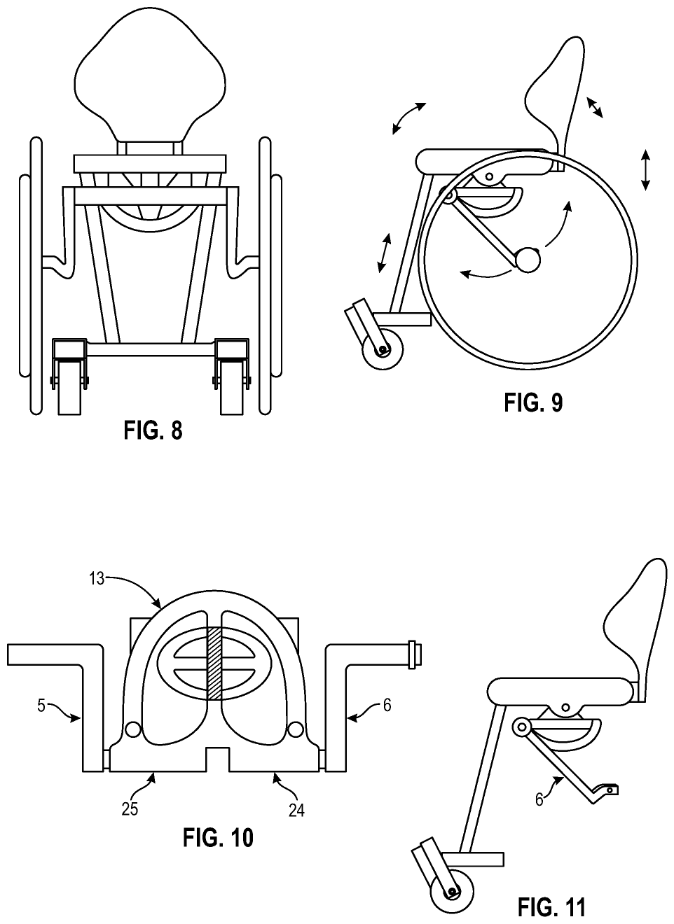

FIG. 7 shows a side elevation of the wheelchair of the same embodiment with first and second wheels removed to illustrate the first and second wheel arms having moved partially through a range or relative alignment such as would occur when the wheelchair leans as illustrated in FIG. 6.

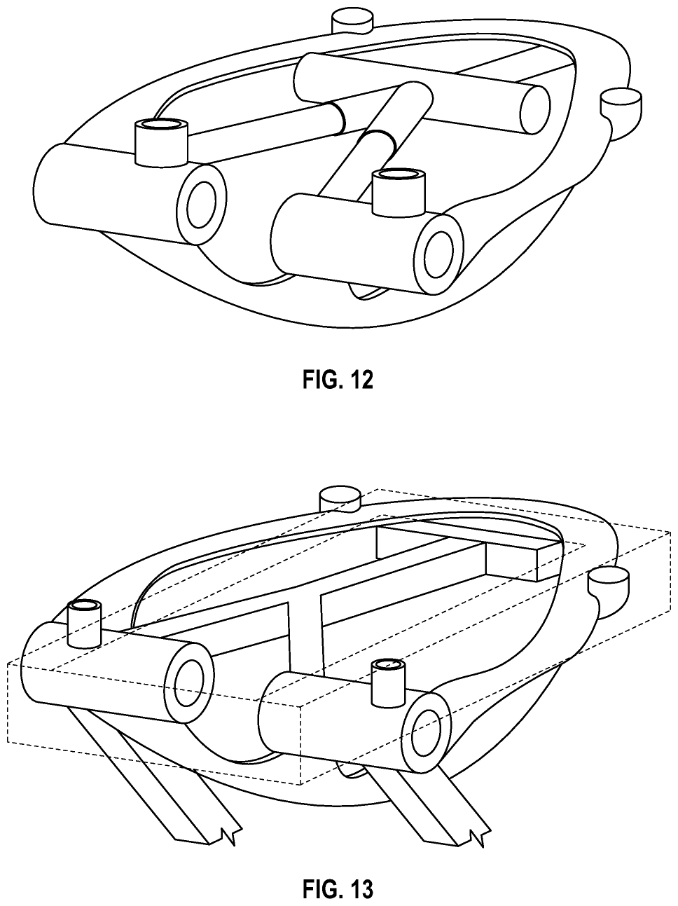

FIG. 8 shows a front elevation of a wheelchair according to the same embodiment.

FIG. 9 shows a side elevation of a wheelchair also of the same embodiment.

FIG. 10 shows a plan view of a central chassis 8 of a wheelchair according to the same embodiment again. FIG. 10 shows the support chassis 13 which allows the seat to tilt laterally with respect to the direction of travel of the wheelchair. FIG. 11 shows a close-up side elevation illustrating the central chassis 8.

The central chassis has a first bore in a tube 24 to mount an axle (not shown) to mount the first wheel arm and a second bore to mount an axle to mount the second wheel arm.

The seat-mounting chassis 13 has a bore to pivotally mount the seat-bearing chassis so as to allow the seat to tilt laterally. The seat bearing chassis provides a stem for the seat to be supported by the central chassis to act as a support for the rider while allowing the rider's weight to be transferred laterally. The set-bearing chassis has bearing points which engage the central chassis to apply a torque to the central chassis and thereby to the wheel arms to cause them to rotate relatively to raise one wheel relative to the other and trail the raised wheel relative to the other wheel.

Further and additional embodiments will now be described.

FIGS. 12 and 13 show central chassis assemblies according to alternative embodiments of the invention.

In various alternative embodiments the bracing assembly may be arranged to extend down and away from the rear of the seat.

In various alternative embodiments the wheel arms may be aligned in a vertical position.

In various alternative embodiments the wheel arms may be aligned in an orientation where they extend down and forward from the pivot mounts.

In alternative embodiments the first and second wheel arm pivot axes are common to each other, or aligned, when the weight of the rider is centred but able to move relative to each other into distinct axes as the weight is shifted to control the chair into a leaned or tilted configuration.

In alternative embodiments the wheels are mounted on extensible arms which allow the wheels to move out of relative alignment to put the chair into a leaned configuration by way of the arms relatively extending or retracting.

Embodiments of the invention provide a wheelchair with improved response to force components occurring laterally with respect to a surface on which the wheelchair rides.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein or may reside in alternative embodiments or combinations of these features with known equivalents to given features. Modifications and variations of the example embodiments of the invention discussed above will be apparent to those skilled in the art and may be made without departure of the scope of the invention.

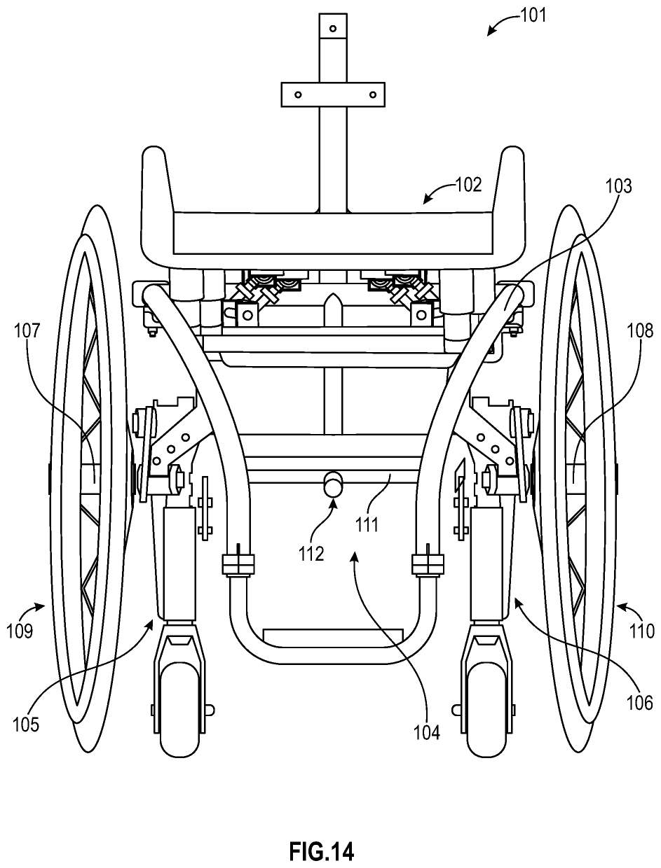

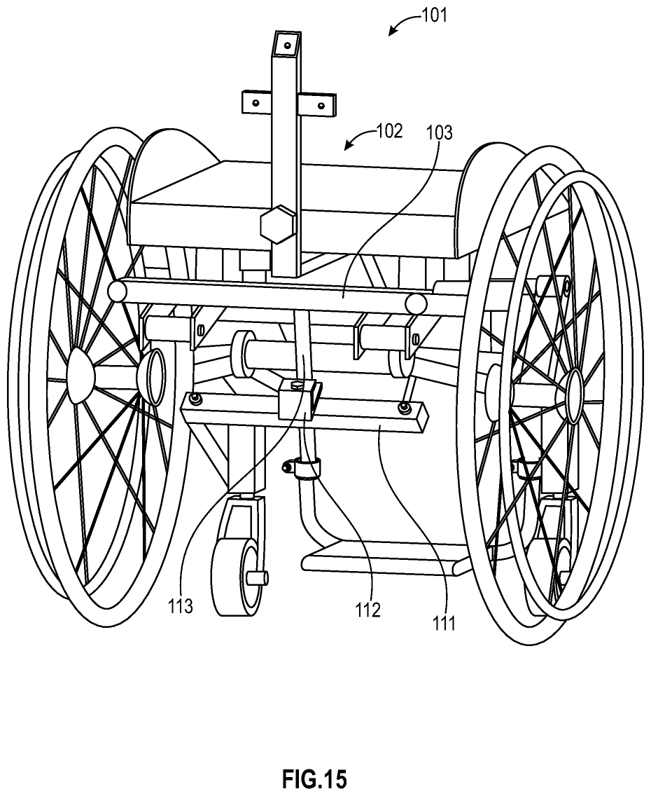

FIG. 14 show a wheelchair 101 according to a further embodiment of the present invention. The wheelchair is shown from a front view.

The wheelchair has a rider platform assembly 102 to support a rider. A seat (not shown) may be attached to the rider platform assembly 102. The rider platform assembly 102 is connected to and mounted by a mid-chassis of the wheelchair 103. A wheel-mounting assembly 104 is connected to the mid-chassis 103 to mount the mid-chassis. The wheel-mounting chassis 104 has a first, right-hand wheel-mounting linkage assembly 105 and a second, left wheel-mounting chassis 106. The wheel-mounting linkage assemblies provide first, right wheel mount 107 and second, left wheel mount 108. A first, right drive wheel 109 is mounted to the right wheel mount linkage assembly 105. A second, left drive wheel 110 is mounted to the left wheel-mounting linkage assembly 106.

A force, distributing means, in the form of a crossbar 111 connects to the right wheel-mounting linkage assembly 1106 and to the second wheel-mounting linkage assembly 106. The crossbar 111 is pivotally mounted at a pivot mount 112 which is connected to the mid-chassis 103. In this example the crossbar acts to evenly distribute the upward force transmitted by each wheel-mounting linkage assembly 105 and 106, and mounted wheel 109 and 110, to the mid-chassis 103. In this example the pivot mount 112 for the crossbar 111 is located between the wheel-mounting linkage assemblies 105 and 105. In this example, the pivot 112 is located half way between the linkage assemblies. The reader may appreciate the crossbar as distributing weight between the wheel-mounting linkage assemblies and mounted first and second wheels. The reader may appreciate the pivotally mounted crossbar as transferring force between the linkage assemblies and mounted first and second wheels.

FIG. 15 shows the wheelchair 101 from a rear view. FIG. 15 shows the pivot mount 112 for the crossbar 111 and shows a stem 113 rigidly connecting the pivot mount 112 to the mid-chassis 103.

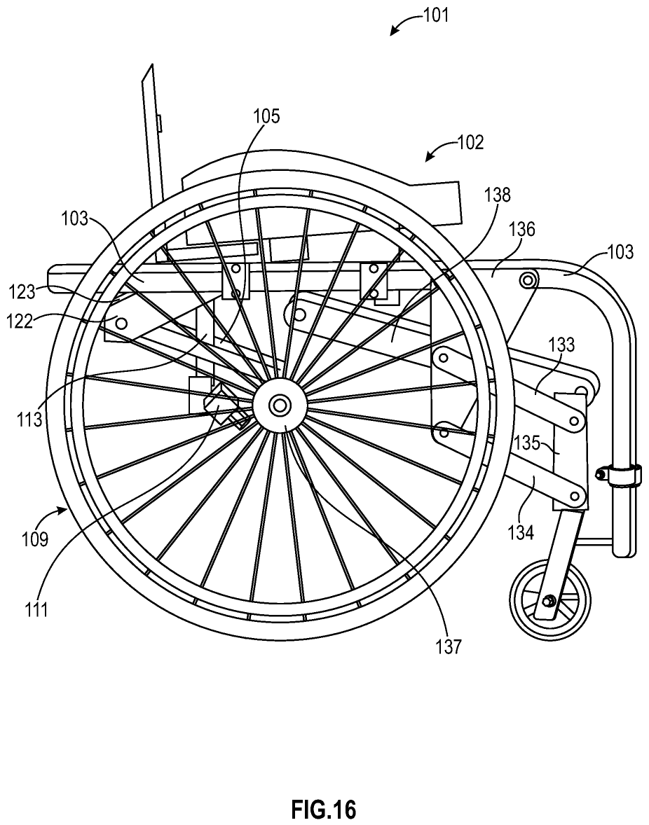

FIG. 16 shows the wheelchair 101 from a side view. The wheel-mounting linkage assembly 105 is shown having a swing-arm 121 mounted at a swing-arm pivot 122 to a swing-arm mounting bar 123 connected to the mid-chassis 103. The swing-arm 121 is able to swing, or pivot to allow the wheel mount and drive wheel 109 to move upward and forward. In this embodiment the movement is in an arc. The crossbar 11 is also shown in FIG. 16.

Also shown in FIG. 16 is a first, right support-wheel mounting assembly 131 which mounts a support wheel 132/The support wheel supports the wheelchair against falling forward in the direction of travel. In this example the support wheel is separated from the drive wheel in the direction of travel and, in this example, forward of the drive wheel.

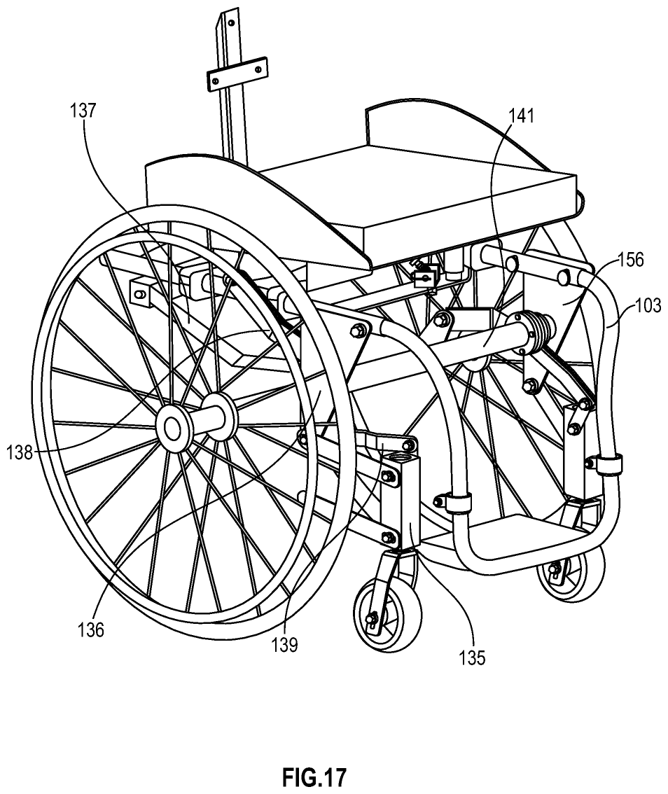

The support-wheel linkage assembly 131 is operable to move the support wheel 132 upward. In this example the support-wheel is moved upwards with the location relative to the drive wheel 109 maintained. In this example the support wheel linkage assembly moves the support wheel 132 in synch with the drive wheel, and the mount for the drive wheel. FIG. 16 shows a linkage 131 having an upper bar 134 and a lower bar 135 connected in a parallel configuration between a forward vertical support linkage bar 135 and rear vertical support linkage bar 136. FIG. 17 shows the wheelchair 101 from a perspective view with first and second wheels at the same relative height as would occur in straight movement on level ground.

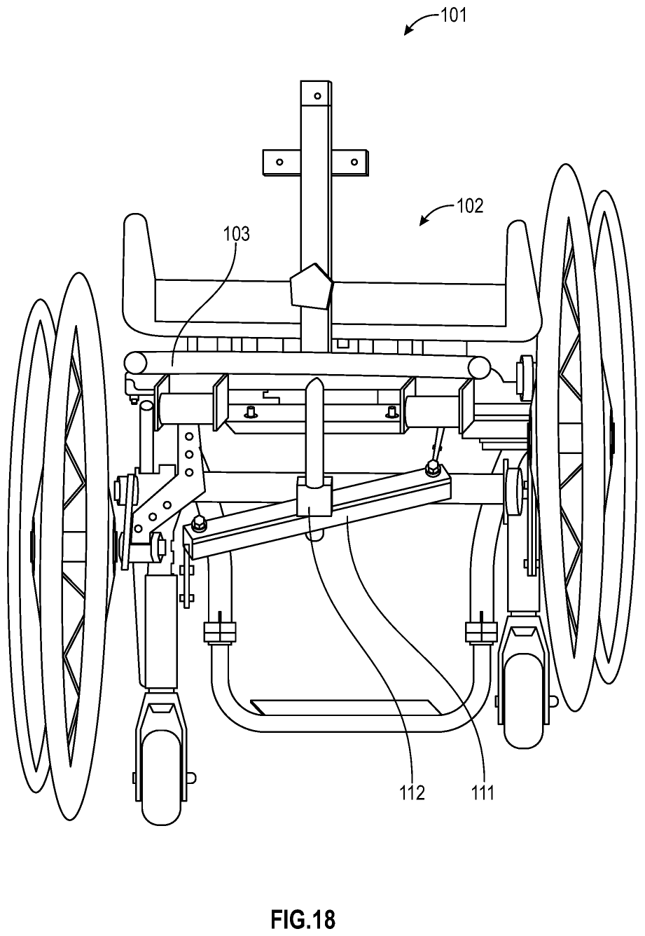

FIG. 18 shows a side elevation view of the wheelchair with the right wheels raised as would occur when the rider leans towards the right to shift their weight lateraly and towards the right.

A cam 137 of the wheel-mounting linkage 105 and support-actuation bar 139 actuate the support linkage 131 as the wheel mount 107 and mounted wheel 109 move.

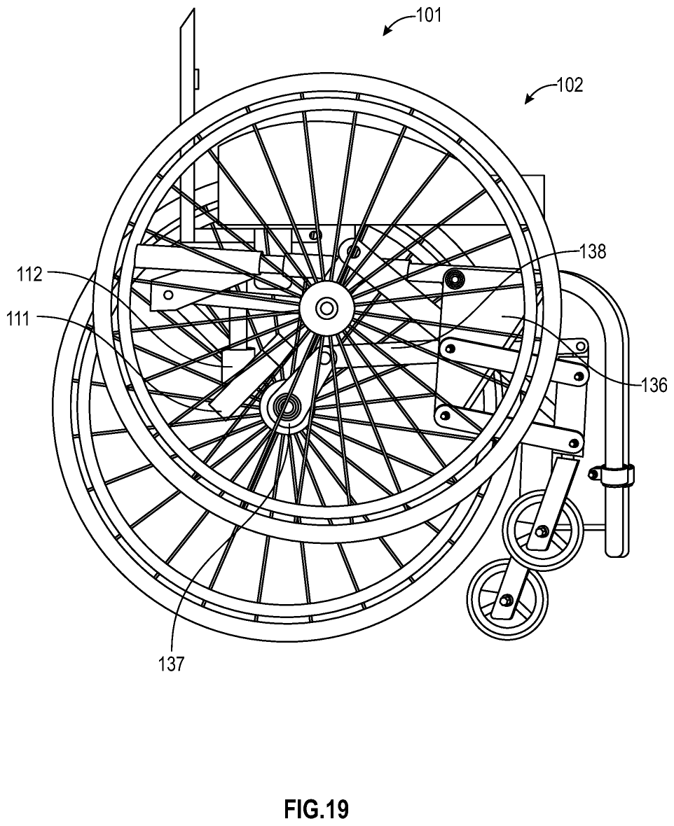

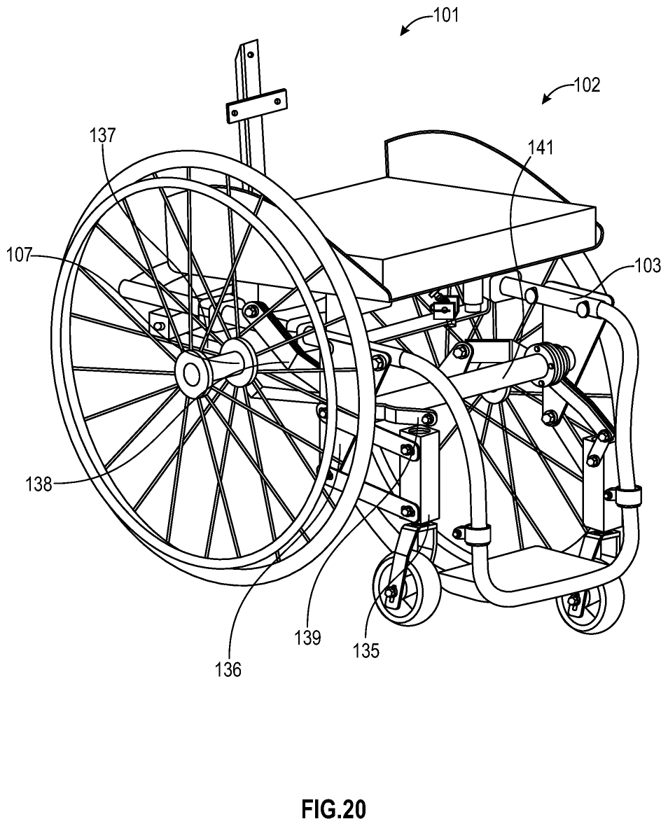

FIG. 19 shows the wheelchair 101 from a perspective view. The wheelchair 101 is in a configuration in which wheels on the right side are raised relative to wheels on the left side. This may occur when the wheelchair 101 traverses a sloped surface. This may also occur when the wheelchair 101 is leaned in towards a centre of a turn to maintain the balance of the wheelchair and rider under centripetal forces.

Shown in FIG. 17 are linkage bars 139 and 140 which lift the vertical bar 135 as the wheel mount 107 is raised. A rod 141 connects to opposite vertical bars 136 and 156 which are mounted on the mid-chassis 103. Also shown in FIG. 17 is a rider foot platform mounted on the mid-chassis 103.

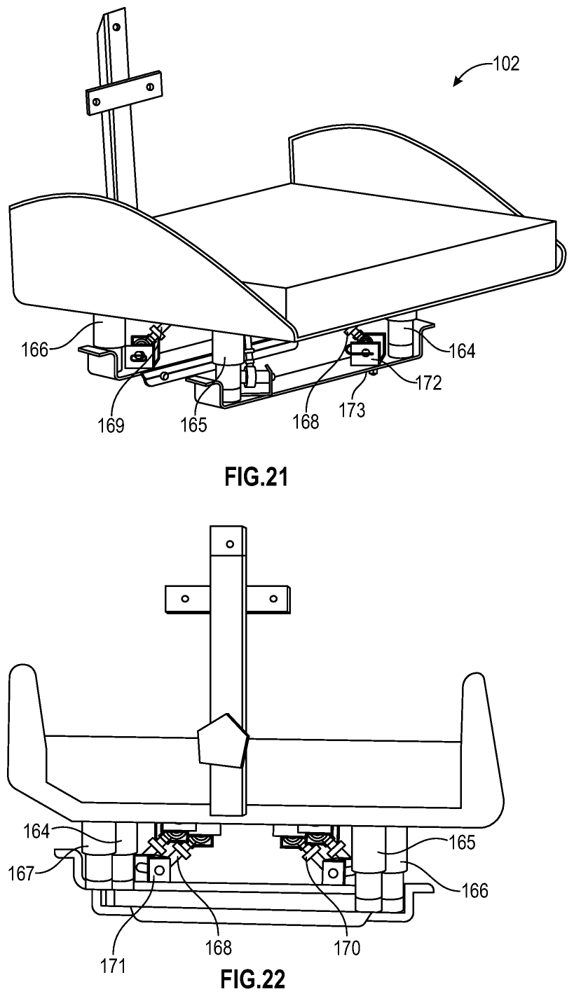

FIG. 21 shows the rider-supporting assembly 102. The assembly 102 has a platform 161, or pan, which supports a seat (not shown) for a rider which is attached to the platform 161.

The platform 161 is connected to mounting bars 163 which are mounted to the mid-chassis 103.

The platform 161 is connected to bars 162 and 163 by double-ended rod ends 168 to 171, which are mounted by brackets, such as 172, and pins 173. The double-ended rods 168 to 171 are arranged in a rectangular pattern connecting the support bars and the seat pan 161. The rod ends allow the seat pan to move through a concave arc. In this example the neutral position is the nadir. In this embodiment this movement can occur in two planes separately or concurrently.

The platform is supported on support bars 162 and 163 by enclosed springs 164 to 167. The four encased compression springs provide stability in the neutral position and provide a biasing force to return from an out-of-vertical position to the neutral position. The reader will recognise this as biasing the pan 161 from a leaned position to a position perpendicular to a plane formed by the support bars 162 and 163. A secondary function of the compression springs is that they act as end stops in their solid state avoiding a collision of the seat pan with the rear wheels in the lateral direction and for the seat pan to tilt backward and forward excessively. The reader will appreciate that the seat-platform support assembly 102 is able to move relative to the mid-chassis. The reader will appreciate that the wheels of the right and left side of the wheelchair are able to move relatively to each other. The reader will also appreciate that movement of the rider platform relative to the mid-chassis is independent of the movement of wheels on right and left sides relative to each other.

In one example use of the embodiment of FIG. 14 a rider in a wheelchair with forward momentum swings their hips transversely to the forward direction of travel. This causes a shift in weight which causes the crossbar to lift one drive wheel relative to the drive wheel on the other side. This in turn causes the wheelchair to initiate a turn. The rider may apply braking to a wheel to assist the turn. The wheelchair makes a turn with, in this example, both the mid-chassis leaned in towards the centre of the turn and the rider-supporting platform leaning in towards the centre of the turn. In this example the rider then swings their hips the opposite way to shift weight away from the centre of the turn. The crossbar then causes the drive wheel at the inside of the turn to lower relative to the drive wheel on the opposite side towards a position where they are at the same height. This causes the wheelchair to track in a straight line, ending the turn.

The reader will appreciate that in some embodiments movement of the rider platform as described and illustrated herein allows the rider to shift weight with respect to the mid-chassis. The reader will appreciate that, in various embodiments, the right and left wheel-mounting linkage assemblies being able to allow the wheel mounts to move upwards relatively to each other and being connected to the crossbar to distribute weight between the wheel mounts 107 and 108, the wheels are able to move relatively to each other to allow the mid-chassis to lean with respect to the surface. The reader will appreciate that, in various embodiments, the movement of right and left wheels relatively to each other occurs in response to the rider shifting weight.

When the wheelchair traverses a slope in a straight line, the uphill facing rear wheel and uphill facing caster will move up and forward relative to the downhill facing rear wheel and caster. This allows the occupant to remain seated vertically.

The rear wheel motion is achieved by means of two swingarms linked together by a pivoting crossbar, or crossbeam.

The caster motion is driven by the motion of the rear wheels, where the right rear wheel moves the left caster, and the left rear wheel moves the right caster. The linkage mechanism crosses over from one side to the other under the seat via the lateral internal and external tubes.

The wheels shown in FIG. 1 or FIG. 14, as two examples, have a weight-bearing, or road-contact, rim and a drive or control rim adapted to be actuated by a rider. The drive or control rim can also be braked by the rider. For example, the rider may grim one or other of the control rims to break one or other of the wheels or to brake or drive both with a differential of braking or driving to affect a turn of the wheel chair. The wheelchairs of the embodiments described herein therefore have a combination of an ability to lean the central chassis or mid-chassis and an ability to selectively brake or drive wheels to affect a turn. The wheelchairs of these embodiments therefore allow the rider to balance the lean of the chair with the instantaneous radius of a turn. The reader will appreciate that balancing in a turn creates a positive neurological effect in a rider. This benefit will be familiar to the reader acquainted with skiing or riding a bicycle for example. The wheelchairs of various embodiments illustrated herein further have an ability to allow the rider to lean the rider-support platform or seat independently. These embodiments allow a rider to balance the leaning, titling or similar of the rider-supporting platform or seat with either or both of the turning of the wheelchair and the leaning of the central-chassis providing further opportunities for the same or similar neurological benefit.

In various embodiments features of the wheelchair are provided on alternative vehicles. Various embodiments provide any combination of the features described and illustrated on any vehicle known as suitable to the reader including mobility scooters, road vehicles, air vehicles and sea vehicles.

In alternative embodiments the force-distributing means is a pneumatic mechanism operable to provide equal upward force to each wheel-mounting linkage assembly.

In various additional embodiments elements, bars, linkages or part described as mounted are attached and/or connected by any attachments known as suitable to the reader.

In various additional embodiments elements, bars, linkages or part described as attached and/or connected are mounted by any mounts known as suitable to the reader.

In alternative embodiments the support wheels are located behind the drive wheels or follow the drive wheels.

In various embodiments the central chassis is a mid-chassis. The reader will recognise that in some embodiments the central chassis and/or mid-chassis support assemblies provide mounts for drive wheels and also provide mounts the platform that supports the rider. In various embodiments a tilt or lean of the rider platform can be independent of the relative height of the drive wheels or first and second wheels. In various embodiments the tilt of the rider platform controls the relative height of the first and second wheels.

Various additional embodiments have any combination of the individual features described and illustrated herein with reference to specific embodiments. For example, one embodiment comprises the features of the embodiment illustrated with reference to FIG. 14 but includes biasing means to bias the swing-arms at each side of the chair into alignment with each other. This may bias the arms towards putting the wheels at the same height. This may assist the rider right the wheelchair.

The rider-support assembly as described herein, such as with reference to FIG. 18, allows the rider to swing their hips in an arc transversely to the direction of travel. The rider-support assembly as described herein, such as with reference to FIG. 18, allows the rider to swing their hips in an arc longitudinally with the direction of travel.

In further alternative embodiments provide a wheelchair with the height of the drive wheels fixed relative to each other with the rider-support assembly as described herein, such as with reference to FIG. 18.

In further alternative embodiments provide a vehicle with the height of the wheels fixed relative to each other with the rider-support assembly as described herein, such as with reference to FIG. 18.

In various additional embodiments various wheels, mounts for the wheel and/or linkages providing mounts for wheels are operable to turn as given wheels, or given other wheels, are raised or lowered relative to others. This may cause or assist the wheelchair to turn as the central chassis or mid-chassis leans.

In various embodiments the tracking of the wheels may be adjustable to tune the steering of the wheelchair, or other vehicle.

1. A wheelchair comprising:
a rider platform support assembly mounted on a mid-chassis and able to move relative to the mid-chassis to allow a rider platform to tilt relative to the mid-chassis;
first and second wheel-mounting assemblies connected to the mid-chassis and providing first and second wheel mounts for first and second drive wheels on respective first and second sides of the wheelchair, wherein the first and second wheel-mounting assemblies are able to allow the wheel mounts to move upwards relatively to each other to allow the mid chassis to tilt relative to a surface on which the wheelchair is riding.

2. The wheelchair of claim 1 wherein the rider platform is able to tilt relative to the mid-chassis to allow the rider to shift their weight relative to the mid-chassis.

3. The wheelchair of claim 2 wherein the wheel-mounting assembly may be operable to move a wheel mount on a first side of the wheelchair relatively upward or downward relatively to a wheel mount on a second side of the wheelchair in response to a shift of weight of the rider relative to the mid-chassis wherein the mid-chassis is able to lean in towards the centre of a turn in response to the rider shifting weight.

4. The wheelchair of claim 3 wherein movement of the rider platform relative to the mid-chassis can be independent of the movement of the first and second wheels on opposite sides relative to each other allow a rider to shift weight relative to the mid-chassis away from the centre of the turn to cause the wheels on opposite sides towards a position where they are at the same height to cause the wheelchair to track in a straight line.

5. The wheelchair of claim 4 wherein the drive wheel at the inside of the turn is caused to lower, by the shifted weight of the rider, relative to the drive wheel on the opposite side towards a position where the first and second wheels are at the same height.

6. The wheelchair of claim 1 wherein the rider platform is articulated to tilt relative to the mid-chassis to allow a rider to apply a torque to the mid-chassis.

7. The wheelchair of claim 6 wherein the wheel-mounting assembly may be operable to move a first wheel mount on a first side of the wheelchair relatively upward or downward relatively to a second wheel mount on a second side of the wheelchair in response to a tilt of the rider platform relative to the mid-chassis wherein the mid-chassis is able to tilt towards the centre of a turn.

8. The wheelchair of any one of claim 1 wherein the rider-supporting platform is connected to the mid-chassis by linkages that allow the seat platform to tilt relative to the mid-chassis.

9. The wheelchair of any one of claim 1 wherein the seat platform is operable to tilt side to side relative to a direction of forward travel of the wheelchair.

10. The wheelchair of any one of claim 1 wherein the seat platform is operable to tilt forward and backward relative to a direction of forward travel of the wheelchair.

11. The wheelchair of any one of claim 1 wherein the seat platform is operable to move through a concave arc.

12. The wheelchair of any one of claim 1 wherein the seat platform is operable to move through a concave arc such that a neutral position of the seat platform is at the nadir of the arc.

13. The wheelchair of claim 12 wherein the seat platform is supported by double-ended rods to allow the seat platform to move through the concave arc.

14. The wheelchair of claim 13 comprising biasing elements arranged to provide stability for the seat platform in the neutral position.

15. The wheelchair of claim 14 comprising biasing elements arranged to provide extra help to return the rider-supporting platform from an out-of-vertical position to the neutral position.

16. The wheelchair of any one of claim 1 comprising support-wheel mounts for right and left support wheels for the wheelchair wherein the support-wheel mounts are provided on support linkage assemblies operable to move mounts for the support wheels as mounts for drive wheels move.

17. The wheelchair of claim 15 wherein the support linkage assemblies are operable to move a support on the first side upward and forward relative to a support wheel on the opposite, second side of the wheelchair when a mounted drive wheel on a first side of the wheelchair moves upward and forward relative to a drive wheel mounted on an opposite, second side of the wheelchair.

18. The wheelchair of claim 15 wherein a wheel mounting linkage comprises a swingarm operable to swing in a plane substantially parallel to a plane in which the wheel mounted on the respective linkage assembly rotates.

19. The wheelchair of claim 18 wherein the seat-bearing chassis has bearing points which engage the central chassis to apply a torque to the central chassis and thereby to the swing arms to cause them to rotate relatively to raise one wheel relative to the other and trail the raised wheel relative to the other wheel.

20. The wheelchair of claim 1 comprising wheels, mounts for the wheels and/or linkages providing mounts for wheels operable to turn as other wheels, are raised or lowered relative to others to assist the wheelchair to turn as the mid-chassis tilts.
